(19) United States
(12) Patent Application Publication
(10) Pub. No.: US 2024/0004206 A1
(43) Pub. Date: Jan. 4, 2024

(54) HEAD-MOUNTABLE ELECTRONIC DEVICE SPACER

(71) Applicant: Apple Inc., Cupertino, CA (US)

(72) Inventors: Paul X. Wang, Cupertino, CA (US); Liam R. Martinez, San Francisco, CA (US); Samuel G. Smith, San Francisco, CA (US); Adam Y. Kollgaard, Santa Cruz, CA (US)

(21) Appl. No.: 18/342,527

(22) Filed: Jun. 27, 2023

Related U.S. Application Data
(60) Provisional application No. 63/367,472, filed on Jun. 30, 2022.

(51) Int. Cl. G02B 27/01

(52) U.S. Cl. CPC G02B 27/0176; G02B 27/0172; G02B 2027/0154

(57) ABSTRACT

A head-mountable device includes a display portion having a housing and a display, a light seal extending from the housing and including offset from the housing by a distance, and an adjustment mechanism coupled to the housing and the light seal and configured to alter the distance.

### CROSS-REFERENCE TO RELATED APPLICATION(S)

This claims priority to U.S. Provisional Patent Application No. 63/367,472, filed 30 Jun. 2022, and entitled “HEAD-MOUNTABLE ELECTRONIC DEVICE SPACER,” the entire disclosure of which is hereby incorporated by reference.

### FIELD

The described embodiments relate generally to wearable electronic devices. More particularly, the present embodiments relate to adjustment mechanisms, devices, and systems for wearable electronic devices.

### BACKGROUND

Recent advances in portable computing have enabled head-mountable devices that provide augmented and virtual reality (AR/VR) experiences to users. Various components of these devices, such as displays, viewing frames, lenses, batteries, motors, light seals, speakers, and other components, operate together to provide an immersive experience. Each user has unique anatomical features, including head size, eye location, cheek and forehead bone structure, and so forth, which must be accommodated by the head-mountable device to provide a custom, comfortable fit for a fully immersive experience. A user, upon donning a head-mountable device, may need to make adjustments to provide the intended customized experience. These adjustments may include adjusting straps, viewing frames, lens width, depth spacing, speaker volume, component locations, or other desired adjustments. Adjustments to the viewing frame spacing and lenses can be particularly important, since these adjustments affect the visual quality and content of the device as experienced by the user.

Some devices may only provide a limited number of adjustments and may not be calibrated to the user, which can cause an image to become distorted when a user is viewing visual content, detracting from an optimal viewing experience. Additionally, creating variations of a single device to accommodate individual users can create the need for additional stock keeping units (SKUs) in addition to adding time, manufacturing complexity, and cost to the product.

Therefore, what is needed in the art are devices and systems capable of providing user specific spacing for head-mountable devices to meet the individual needs of the user.

### SUMMARY

In one example of the present disclosure, a head-mountable device includes a display portion having a housing and a display, a light seal extending from the housing and including offset from the housing by a distance, and an adjustment mechanism coupled to the housing and the light seal and configured to alter the distance.

In one example, the light seal includes a compliant sheath defining an internal volume. In one example, the adjustment mechanism includes a foot disposed at least partially within the internal volume. In one example, the head-mountable device further includes a frame coupled to the housing, wherein the foot connects to the frame and an angle of the foot relative to the frame is adjustable. In one example, the head-mountable device further includes a frame, wherein the housing defines an external surface of the display portion, the housing is coupled to the frame, and the adjustment mechanism is coupled to the frame. In one example, the adjustment mechanism is coupled to the frame and extends into the light seal. In one example, the light seal and the housing hide the adjustment mechanism from view.

In one example of the present disclosure, an electronic display device includes a housing defining a front side and a rear side, and a light seal extending from the rear side, the light seal having an upper portion extending a first distance from the housing and a lower portion extending a second distance from the housing; and an adjustment mechanism configured to alter the first distance or the second distance.

In one example, the upper portion is a first upper portion and the lower portion ins a first lower portion, the light seal further including a second upper portion extending a third distance from the housing and a second lower portion extending a fourth distance from the housing. In one example, the adjustment mechanism is configured to independently alter the first distance, the second distance, the third distance, and the fourth distance. In one example, the display device further includes a frame, the housing coupled to the frame, wherein the adjustment mechanism includes a first foot coupled to the frame and a second foot coupled to the frame. In one example, the first foot is coupled to the frame via a variable length mechanism. In one example, the first foot is coupled to the frame via a pivot mechanism. In one example, the electronic display device further includes a frame to which the housing is attached, wherein at least one of the first foot and the second foot is coupled to the housing via the frame. In one example, the electronic display device can further include a display, wherein adjusting the first distance or the second distance alters an angle or distance of the display relative to a user's eye.

In one example of the present disclosure, a head-mountable electronic device includes a display portion having a display screen, a light seal connected to the display component, the light seal including an adjustment mechanism, and a securement strap configured to hold the display screen in front of an eye at a distance and an angle relative to the eye, wherein the adjustment mechanism is configured to alter the distance and the angle.

In one example, the light seal defines a contact surface to press against a face around the eye and block ambient light from impinging on the display screen. In one example, the adjustment mechanism includes a first variable length mechanism couple to the housing and a second variable length mechanism coupled to the housing. In one example, changing the length of the first variable length mechanism alters the distance or the angle. In one example, the light seal defines an internal seal volume and the adjustment mechanism is disposed within the internal volume.

### BRIEF DESCRIPTION OF THE DRAWINGS

The disclosure will be readily understood by the following detailed description in conjunction with the accompanying drawings, wherein like reference numerals designate like structural elements, and in which:

FIG. 1 shows a top view of a user donning an example of a head-mountable device;

FIG. 2 shows a side, cross-sectional view of a head-mountable device donned by a user;

FIG. 3 shows a rear, perspective view of an example of a display portion of a head-mountable device;

FIG. 4 shows an example of contact regions of a head-mountable device overlying the face of a user;

FIG. 5A shows a side, cross-sectional view of a head-mountable device donned by a user;

FIG. 5B shows another side view thereof with the device adjusted to a different user;

FIG. 5C shows another side view thereof with the device adjusted to a different user;

FIG. 6 shows a side, cross-sectional view of an example of a display portion of a head-mountable device;

FIG. 7 shows a side, cross-sectional view of an example of a display portion of a head-mountable device;

FIG. 8 shows a side, cross-sectional view of an example of a display portion of a head-mountable device;

FIG. 9 a side, cross-sectional view of an example of a display portion of a head-mountable device;

FIG. 10 shows a side, cross-sectional view of an example of a display portion of a head-mountable device;

FIG. 11 shows a side, cross-sectional view of an example of a display portion of a head-mountable device;

FIG. 12 shows a perspective view of a portion of an example of a head-mountable device including a number of adjustment mechanisms;

FIG. 13 shows a top view of a portion of an example of a head-mountable device including adjustment mechanisms;

FIG. 14A shows a top view of an example of a head-mountable device; and

FIG. 14B shows a top view of an example of a head-mountable device.

### DETAILED DESCRIPTION

Reference will now be made examples illustrated in the accompanying drawings. It should be understood that the following descriptions are not intended to limit the examples to one preferred embodiment. To the contrary, it is intended to cover alternatives, modifications, and equivalents as can be included within the spirit and scope of the described embodiments as defined by the appended claims.

The following disclosure relates to wearable electronic devices. More particularly, the present embodiments relate to adjustment mechanisms and spacers, devices, and systems for head-mountable electronic devices that are simpler, require less parts than conventional adjustment mechanisms, and which can be easily, precisely, and accurately adjusted by the user, retailer, or manufacturer without the need for multiple SKUs. When donning wearable electronic devices, including head-mountable AR/VR devices described herein, the position of certain components of the device relative to certain features of the user can affect the quality of the user experience. One example includes the distance of one or more displays relative to the user's eyes. Each user may have unique facial characteristics, such as variations of cranial width or length, which can be caused by variations in facial bones that press against head-mountable electronic devices. The facial anatomical variations between users complicate the issue of providing components positioned within the tight dimensional tolerances relative to the user's eyes required for an optimum viewing experience.

Additionally, the adjustment mechanisms and adjustment spacers for electronic devices described herein can be manufactured using a minimal number of SKUs while enabling user specific adjustments to customize the placement distance and angle of displays, lenses, or other components of head-mountable electronic devices. The adjustment mechanisms can enable users to easily self-adjust components or manufacturers and retailers to adjust components as needed to accommodate each user profile, providing an optimal viewing experience for the user. In at least one example, adjustment of the angle and distance of the display screen can be modified by an adjustment mechanism coupled to a housing and a light seal. The light seal can be designed to press against the user's face, for example around the user's eyes and over the nose, to minimize outside light exposer to the user while maintaining an optimal viewing distance and angle of the display screen as applicable to the user.

In another example, a light seal, which can be constructed of a compliant material, can extend from the housing by use of an adjustment mechanism containing a foot. The foot of the adjustment mechanism can press against the user's face in such a way that light is minimized and the correct viewing distance and optimum viewing angle is maintained. In doing so, the user is provided with a more immersive individual experience. Similarly, there can be two, four, six, eight, or more adjustment mechanisms that are each tailored to the particular facial anatomical variations of the user. This can provide the user with increased levels of comfort while properly shielding the user from external light pollution, which can be caused by ambient light, by having the adjustment mechanisms at least partially embedded within the internal volume of the light seal.

In at least one example, the electronic display device can have a light seal extending from a peripheral edge of the rear side, having an upper and lower portion that are independently adjustable to conform to the user's facial profile. These upper and lower portions can have multiple adjustable mechanisms, which can be independently configured to alter each of the first, second, third, or fourth distance relative to the users face. These independently adjustable portions can be configured directly or indirectly to pivot, rotate, slide, translate, step, or otherwise move via a pivot attachment. In one example, the adjustment mechanisms can be manually adjusted by the user, manufacturer, or retailer. Additionally or alternatively, in one or more examples, the adjustment mechanisms can be electronically actuated.

The pivot attachment can be machined, injection molded, formed, stamped, printed using additive manufacturing techniques, or created using any other manufacturing method whereby the pivot attachment can accomplish the intended task of conforming to the user's facial profile. In this way the user's viewing experience can be augmented and customized to the anatomical features of the user. Similarly, the pivot attachment can be attached to a foot either directly or indirectly. The foot can provide additional customization and comfort to the user, further augmenting the user's viewing experience.

In another example, the electronic display device can be conformed to the user's facial anatomical features by means of a shim or spacers, or a combination thereof. The shims or spacers can be connected to the electronic display device by mechanical latches, magnetic interfaces, snap fit connections, or by other connection methods intended to secure the shims or spacers to the electronic display device. These shims or spacers can be designed to accommodate a range of users per SKU, which can reduce the total SKUs required, simplifying the manufacturing process and reducing cost while still being user adaptable to provide an optimized viewing experience. The shims or spacers can be placed in between the electronic display device and light seal being visible to the user, or the shims or spacers can be contained inside the light seal, being hidden from the user. An optimized viewing widow can be created for each user and can be a function of screen angle and distance relative to the user's eyes, which can vary user to user and is dependent on the anatomical features of the user. A functional envelope can define the limits in which the viewing window is optimized, which can be between about 2 mm and 100 mm, for example between about 5 mm and 50 mm, between about 10 mm and 40 mm, or more specifically between about 15.0 mm and 30 mm in distance relative to the user's eyes. The correct combination of depth and angle for an individual user can be accomplished by use of a shim, spacer, or other mechanical or electromechanical methods of producing a user specific angle and distance combination that is contained within the functional envelope of optimized viewing.

In yet another example, the light seal can have an internal volume wherein the adjustment mechanism can be placed, covering the light seal from view. The adjustment mechanism can be continuous, consisting of one facial contacting portion attached to the electronic display device, or it can be discrete, consisting of a multiple face contacting parts working cooperatively to appropriately conform to the user's facial profile. In doing so, the light seal is able to press against the face and block ambient light from impinging on the display screen, while also providing appropriate screen distance and angle specific to the user relative to the user's eyes.

As a result of the devices described herein can provide a head-mountable device with additional advantages than previously available, such as user or manufacturer adjustable screen distance and angle features that are continuous and adjustable, which can better meet the individual needs of each user without the need for the manufacturer to produce additional SKUs.

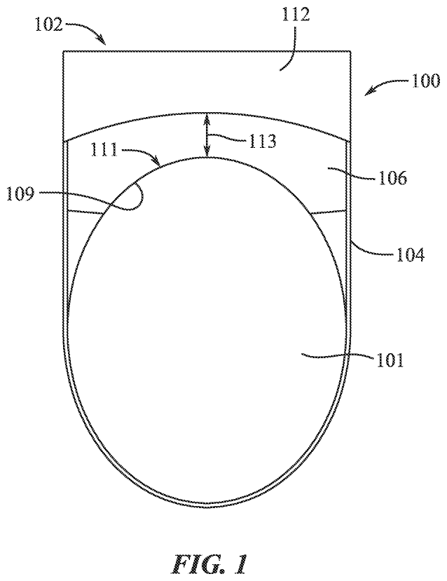

These and other embodiments are discussed below with reference to FIGS. 1-13. However, those skilled in the art will readily appreciate that the detailed description given herein with respect to these figures is for explanatory purposes only and should not be construed as limiting. Furthermore, as used herein, a system, a method, an article, a component, a feature, or a sub-feature comprising at least one of a first option, a second option, or a third option should be understood as referring to a system, a method, an article, a component, a feature, or a sub-feature that can include one of each listed option (e.g., only one of the first option, only one of the second option, or only one of the third option), multiple of a single listed option (e.g., two or more of the first option), two options simultaneously (e.g., one of the first option and one of the second option), or combination thereof (e.g., two of the first option and one of the second option).

FIG. 1 illustrates a top view of a head-mountable device 100, including a display portion 102 having a housing 112 and a display screen secured by, on, or within an internal volume defined by the housing 112. The display screen is not shown in FIG. 1 but will be described in more detail with reference to other figures. The device can also include a light seal 106 extending from the housing 112 to contact the user 101. A securement strap 104 can extend from the display portion 102 and/or the light seal 106 and around the head of the user 101 to secure the device 100 against the face 111 of the user 101. In particular, in at least one example, the securement strap 104 can press inward around the head of the user 101 to press the light seal 106 against the face of the user 101.

In the top view of FIG. 1, a user 101 is shown donning the device 100. In at least one example, the light seal 106 can extend from the housing 112 and include a contact surface 109. The contact surface 109 can form to the shape of the user's face 111 and be offset from the housing 112 by a distance 113. In at least one example, the light seal 106 can be formed of elastic or compliant material such that when the securement strap 104 presses the device 100 against the face of the user 101, the light seal compresses conform to the user's face 111. In one example, the light seal 106 is formed with the contact surface 109 configured complimentary to the contours of the user's face 111. The conformation of the light seal 106 to the user's face 111, and more particularly the conformation of the contact surface 109 to the user's face 111, creates a seal between the user's face 111 and the display portion 102 or housing 112 thereof in order to block light from the ambient environment external to the device 100 from impinging on one or more display screens of the display portion 102 projecting light to the user's face 111 during operation.

In at least one example, the distance 113 from the housing 112 to the contact surface 109 can vary at different points or locations along the light seal 106 as the light seal 106 conforms to the user's face 111. The device 100 can include a display portion 102 having a housing 112 that is manufactured and formed as a single SKUs according to common dimensions, size, and shapes regardless of the anatomical variations of different users 101 while the light seal 106 conforms as noted above to accommodate the various unique features and shapes/contours of different users 101. The light seal 106 can also include a single SKU that is conformable or alterable in some way to accommodate different anatomical features of different users 101. In general, the light seal 106 is configured to contact the user's face 111, including the forehead, cheeks, nose, and other anatomical features surrounding the eyes of the user 101.

The consistent contact of the contact surface 109 against the user's face 111 can block out light from the external environment to isolate light projected toward the user's eyes by the display portion 102 for the best quality visual experience. The display portion 102 of the device 100 can include one or more displays, including one or more display screen's not shown in FIG. 1, arranged with, on, or within the display portion 102 or the housing 112 thereof. The displays can be configured to direct light and images toward the eyes of the user 101 when the device 100 is donned, as shown in FIG. 1. Light seals 106 described herein can include one or more adjustment mechanisms, including adjustment spacers, to alter the distance 113 between the contact surface 109 and the housing 112 at various points or locations along the light seal 106 while maintaining the consistent contact between the contact surface 109 and the user's face 111 for light sealing purposes. It is noted that the distance 113 shown and labeled in FIG. 1 indicates the distance between the display portion 102 or the housing 112 thereof and the user's face 111 at one point of contact between the contact surface 109 of the light seal 106 and the user's face 111. The distance 113 can vary from one point of contact to another due to the conforming nature of the light seal 106 discussed above. That is, the distance 113 separating the display portion 102 from the user's face 111 by the light seal 106 can vary around the user's face 111.

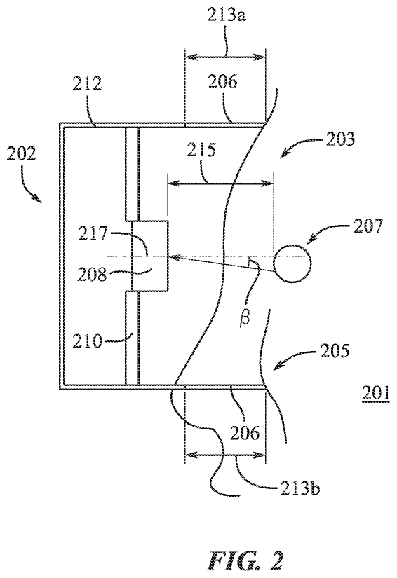

In addition, the distance 113 shown in FIG. 1 references a position of the housing 112 relative to the user's face 111. However, as will be described in more detail below with reference to other figures, the distance 113 can also indicate the position of one or more displays (not shown in FIG. 1) relative to the user's face 111 and more particularly relative to the eyes of the user 101. That is, the display portion 102 can include a display such as a display screen fixed in position relative to the housing 112 of the display portion 102. Thus, when referencing the distance 113 of the housing 112 relative to the user's face 111, the distance 113 provided by the light seal 106 can also determine the distance of the display screen connected to the housing 112 relative to the eyes of the user 101. Such displays of the display portion 2 are shown in subsequent figures, including at least FIGS. 2-3 and 5A-11, and described below.

Any of the features, components, and/or parts, including the arrangements and configurations thereof shown in FIG. 1 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 1.

FIG. 2 illustrates a side view of a user 201 donning including a display portion 202 of a head-mountable device. FIG. 2 shows a cross-sectional view of the display portion 202. In at least one example, the display portion 202 can include a housing 212 and a light seal 206 extending from the housing 212 to contact the user 201. In particular, a first portion of the light seal 206 can extend from the housing 212 to the forehead 203 of the user 201 and another portion of the light seal 206 can extend from the housing 212 to the cheek 205 of the user 201. In addition, in at least one example, the display portion 202 can include a frame 210. A display 208 can be secured, connected, or coupled with the display portion 202 via the frame 210. In one or more other examples, the display 208 can be coupled to the housing 212 of the display portion 202.

In at least one example, the display 208 can include a display screen configured to direct light towards the user's eye 207 when the user 201 dons the display portion 202. As shown in FIG. 2, the display portion 202 can be secured against the user's face, including the forehead 203, the cheek 205, and other facial anatomical features surrounding the user's eye 207 such that the display 208 is configured to direct light toward the user's eye 207 during use. As noted above, the light seal 206 can define a distance 213 separating the housing 212 from the user 201. As shown in the cross-sectional view of the display portion 202 of FIG. 2, the light seal 206 can define multiple distances 213a, 213b separating the housing 212 from the face of the user 201. As noted above, the face of the user 201 can include the user's forehead 203, cheek 205, and any other portion of the user 201 surrounding the eye 207, including the nose, temples, and so forth. For example, an upper portion of the light seal 206 can define a first distance 213a between the housing 212 and the forehead 203 while a second lower portion of the light seal 206 can define a second distance 213b between the housing 212 and the cheek 205.

Also, FIG. 2 illustrates the display 208 coupled to the housing 212 via the frame 210 such that the distances 213a and 213b determine another distance 215 between the user's eye 207 and the display 208. In addition, in at least one example, the light seal 206, due to the different distances 213a and 213b separating the housing 212 from the forehead 203 and the cheek 205, respectively, the light seal 206 can also determine an angle β of a gaze direction of the eye 207 relative to a direction 217 normal to a surface of the display 208 facing the eye 207.

In at least one example of the present disclosure, the light seal 206 can include adjustment spacers and mechanisms to alter the distances 213a, 213b in order to alter the distance 215 between the display 208 and the eye 207 as well as alter the angle β of the display 208 relative to the eye 207. The adjustment spacers and mechanisms, which are not shown in FIG. 2, can be automatically and/or manually adjusted by the user 201, by a manufacturer, or by a retailer in order to customize the distance 215 and the angle β according to the unique anatomical variations of the user 201. In this way, visual outputs of the display 208 can be optimized for the user 201, including focal length, depth, and angle β relative to the eye 207, to produce focused and high-quality images to the user without the need for multiple SKUs of the display portion 202, including the housing 212, light seal 206, or any other component thereof, to accommodate variations in features of multiple users.

In some examples, the head-mountable devices described herein can include one or sensors or cameras to detect and determine a topographical map of the user's face including measurements of the anatomical features of the user to form the facial map or identification. In at least one example, the user can use a separate device including a smartphone or other electronic device to determine and generate the facial map. The information associated with this facial map can be linked to a user account or otherwise provided to the manufacturer or the retailer. The manufacturer or the retailer can adjust the light seal 206 as needed to provide an optimal distance 215 and angle β of the display 208 relative to the eye 207. In one or more other examples, the user can adjust the light seal 206, including the resulting distances 213a and 213b, to adjust the distance 215 and angle β to customize the display portion 202.

Any of the features, components, and/or parts, including the arrangements and configurations thereof shown in FIG. 2 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 2.

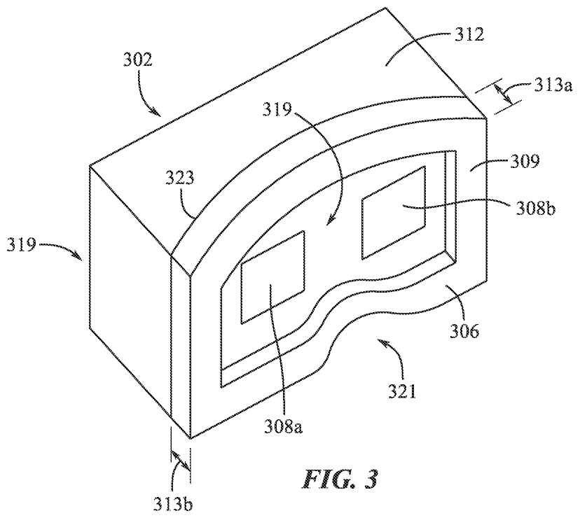

FIG. 3 illustrates a rear prospective view of a display portion 302 of a head-mountable device including a housing 312 and a light seal 306. The display portion 302 also includes first display 308a and a second display 300b. First display 308a can be configured directly light toward the left eye of the user and the second display 308b can be configured direct light toward a right eye at the user. The light seal 306 can include a contact surface 309 configured to press against the face of a user when the display portion 302 is donned. The light seal 306 and the contact surface 309 thereof can define various distances 313a, 313b separating the housing 312 from the user's face and thus, as described above, also determine the distances and viewing angles of the displays 308a, 308b relative to the eyes of the user.

The light seal 306 can be configured such that the contact surface 309 forms a barrier with the user's face to prevent ambient light external to the display portion 302 from impinging on the displays 308a and 308b. While only two distances 313a and 313b between the housing 312 and the user's face are labeled in FIG. 3, any number of unique distances between the housing 312 and the user's face can be defined by the light seal 306. That is, the light seal 306 can include varying thicknesses, depths, and other dimensions to vary the distance between the user's face and the housing 312 in order to position the displays 308a, 308b optimally relative to the user's eyes.

In at least one example, the light seal 306 can extend peripherally around the inner edge of the housing 312 of the display portion 302. In at least one example, the housing 312 can define a front side 319 and a rear side 321. The housing can define a peripheral edge 323 around a periphery of the rear side 321 and the light seal 306 can extend rearward from the rear side and at or corresponding in position with the peripheral edge 323. The light seal 306 can extend rearward from the housing 312 shown in FIG. 3 to define the viewing volume 329 wherein the displays 308a and 308b project light toward the user's eyes. Ambient light external to the display portion 302 is blocked from entering the viewing volume 329 based on the contact between the user's face and contact surface 309 of the light seal 306. In at least one example, the contact surface 309 of the light seal 306 is a continuous, unbroken surface providing a complete barrier to ambient light entering the viewing volume 329. In at least one example, no portion of the contact surface 309 of the light seal 306 is separated or not in contact with the user's face.

Any of the features, components, and/or parts, including the arrangements and configurations thereof shown in FIG. 3 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 3.

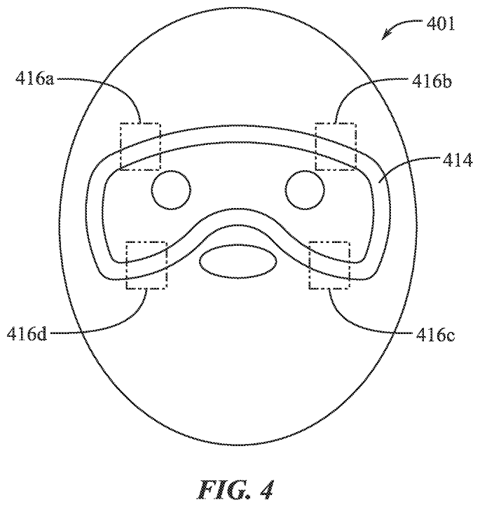

FIG. 4 illustrates a user 401 with a representation of a contact region 414 and four data ends overlaid on the user's face. The contact region 414 represents an area of the user's face that may be contacted by the various light seals described herein. The contact region encloses the user's eyes such that light projected to the user's eyes via the one or more devices and displays described herein is isolated from ambient light of the external environment. The contact region 414 can also extend across the bridge of a user's nose and be shaped to conform to the typography of the face over the nose, on the cheeks, and around the user's eyes to the forehead as shown.

In addition, FIG. 4 also illustrates four contact datum locations 416a-d. The contact datum locations 416a-d shown in FIG. 4 represent approximate locations where adjustment mechanisms altering the thickness of a light seal, and therefore a distance of a display housing relative to the user's face, can be located. Manipulating adjustment mechanisms located at these contact datum locations 416a-d, in at least one example, can be sufficient to adjust the light seal of devices described herein and thus adjust relative positions and angles of display screens of devices described herein to customize head-mountable devices to specific users regardless of varying facial dimensions and anatomical features.

In particular, in the example shown in FIG. 4, first and second datum locations 416a and 416b can be located on opposing left and right sides of the user's forehead. Third and fourth contact datum locations 416c and 416d can be located on opposing cheeks of the user on either side of the user's nose. One or more other examples can include contact datum locations of adjustment mechanisms of light seals described herein at other locations on the user face. In addition, one or more examples of head-mountable devices described herein can include less than four adjustment mechanisms correlating to less than four contact datum locations. One or more other examples of head-mountable devices described herein can include more than four adjustment mechanisms correlating to more than four contact datum locations. FIG. 4 merely illustrates one non-limiting example of contact datum locations 416a-d illustrating that separate and discrete adjustment mechanisms located at separate and discrete contact datum locations 416a-d can be utilized to adjust and customize head-mountable devices described herein.

Any of the features, components, and/or parts, including the arrangements and configurations thereof shown in FIG. 4 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 4.

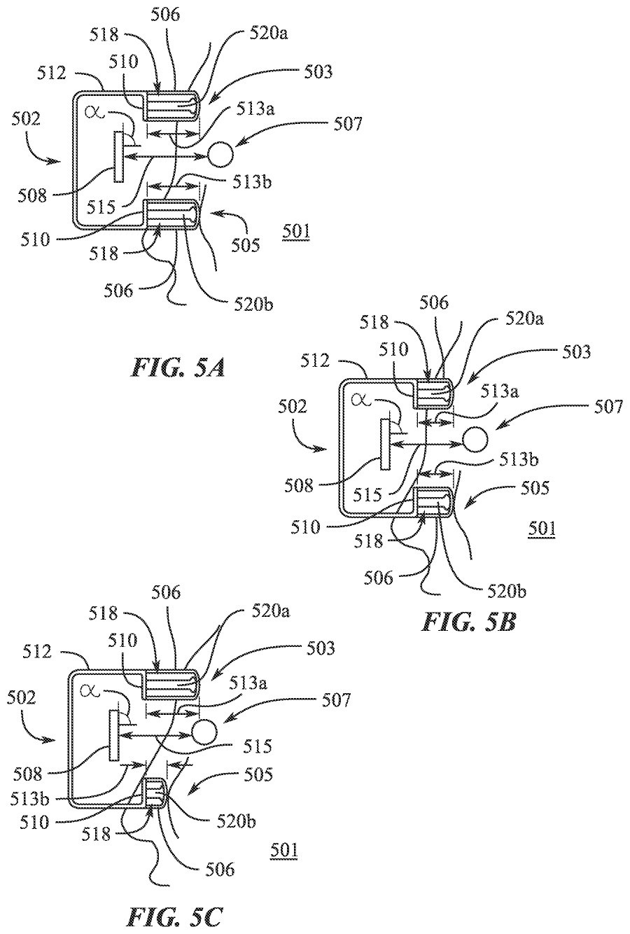

FIGS. 5A-5C illustrate the user 501 donning a head-mountable device including a display portion 502. The display portion 502 can include a housing 512 and a display 508, for example a display screen, disposed on, within, or otherwise coupled with the housing 512. In at least one example, the display portion 502 also includes a light seal 506 extending from the housing 512 and contacting the user 501. A first or upper portion of the light seal 506 can extend from the housing 512 and contact the user's forehead 503. A second or lower portion of the light seal 506 can extend from the housing 512 and contact the user's cheek 505.

In at least one example, anywhere the light seal 506 contacts the user, for example at the forehead 503 and at the cheek 505 as shown in FIG. 5A, the light seal can define a distance separating the housing 512 from the face of the user 501 and thus define a distance of 515 separating the display 508 from the user's eye 507 due to the coupling between the display 508 and the housing 512. For example, the first or upper portion of the light seal 506 can define a first distance of 513a separating the housing 512 from the forehead 503 of the user 501. Likewise, the second or lower portion of the light seal 506 can define a second distance 513b separating the housing 512 of the display portion 502 from the cheek 505 of the user 501. In order to optimally position the display 508 relative to the user's eye 507, including defining the distance 515 indicated in FIG. 5A, the first distance 513a and the second distance 513b can be the same or different.

In at least one example, the display portion 502 can include a light seal 506 having a sheath that defines an internal volume 518. In one example, the sheath can be a compliant or elastic material that can expand, reduce, and elastically return to a resting shape when not acted upon by any forces. That is, in at least one example, the light seal 506 can be formed of a material whose dimensions can be altered to change the first and second distance is 513a and 513b shown in FIG. 5A. In addition, in at least one example, the display portion 502 can include one or more adjustment spacers or mechanisms 520a and 520b to alter the light seal 506 in such a way so as to alter the first and second distances 513a and 513b associated with different portions of the light seal 506. The adjustment mechanisms described herein, including adjustment mechanisms 520a and 520b, can be referred to as adjustment spacers, which adjust the distances 513a and 513b. In at least one example, the adjustment mechanisms 520a and 520b define the first and second distances 513a and 513b, respectively.

In one example, a first adjustment mechanism 520a can be disposed within the internal volume 518 at an upper portion of the light seal 506. A second adjustment mechanism 520b can be disposed in the internal volume 518 of a second or lower portion of the light seal 506. Each adjustment mechanism 520 can include a variable length mechanism coupled to the housing 512 and disposed in the internal volume 518 defined by the light seal 506. The variable length mechanism of the adjustment mechanisms can be manipulated to alter an overall length of each of the adjustment mechanisms 520a and 520b. Each of the adjustment mechanisms 520a and 520b shown in FIG. 5A can be similar such that a description of one can apply to the other. The adjustment mechanism 520 a can alternatively be coupled to a frame 510 of the display portion 502. In one example, the frame 510 can be an extension of or a part of the housing 512. In another example, the frame 510 can be a separate frame component connected to or coupled with and supporting the housing 512.

In at least one example, the adjustment mechanism 520a can be coupled to the frame 510 and extend into the light seal 506. In at least one example, the light seal 506, or a sheath defining the internal volume 518 thereof, and the housing 512 can hide the adjustment mechanism 520a or 520b from view. In any case, the adjustment mechanism 520a disposed in the internal volume 518 of the light seal 506 can be coupled to the frame 510 or the housing 512 such that an adjustment of the length of the adjustment mechanism 520a alters the distance 513a and thus the distance 515 between the display 508 and the user's eye 507.

In the example shown in FIG. 5A the display 508 is positioned at some optimal angle α relative to a line of sight of the user's eye 507 for optimal visual performance of the display portion 502. The display 508 is also located at an optimal distance 515 from the user's eye 507. The angle α and the distance 515 are described as optimal herein for illustrative purposes but the distances and angles shown in the figures, including the angle α and the distance 515 shown in FIG. 5A, is not necessarily representative of optimal distances and angles as applied to any one user. Rather, this angle α and this distance 515 will be used to illustrate how an adjustment of the adjustment mechanisms 520a and 520b, and therefore an adjustment of the distances 513a and 513b defined by the light seal 506, can be maintained regardless of a user's anatomical variations.

For example, FIG. 5B illustrates the same display portion 502 of the head-mountable device but worn by a user with dissimilar anatomical features, such as cheek bone structure or forehead position. In order to maintain the optimal distance 515 between the display 508 and the user's eyes 507, as well as maintaining the optimal angle α, the first and the second adjustment mechanisms 520a and 520b can be shortened compared with the adjustment mechanisms 520a and 520b shown in FIG. 5A. As a result, the first and second distances 513a and 513b separating the housing 512 from various portions of the user's face in FIG. 5 be can be different than the distances 513a and 513b shown in FIG. 5A. As a consequence, based on the different anatomical features and dimensions of the user shown in FIG. 5B, the optimal distance 515 between the display 508 and the eye 507 of the user 501 in FIG. 5B can be maintained.

It will also be noted that the optimal distance 515 and the optimal angle α may be different from one user to the other. Thus, rather than maintaining the angle α and the distance 515 between users, the adjustment mechanisms 520a and 520b can be used to alter the angle α and the distance 515 for optimal use unique to each user.

FIG. 5C shows another example of the same display portion 502 being donned by another user 501. According to the unique anatomical features and dimensions of the user 501 shown in FIG. 5C, the first adjustment mechanism 520a has been altered to be longer than the length of the second adjustment mechanism 520b to maintain the optimal distance 515 and angle α of the display 508 for that user 501. The adjustment to the length of the adjustment mechanisms 520a and 520b results in a corresponding change to the first and second distances 513a and 513b defined by the light seal 506 separating the housing 512 and or the frame 510 from the various contact datum locations of the light seal 506 pressing against the user 501. In at least one example, changing the lengths of the adjustment mechanisms 520a and 520b independently of one another can alter the angle α of the display 508 relative to the eye 507 as well as affecting the distance 515.

The adjustment mechanisms and adjustable light seals of head-mountable devices described herein, in addition to optimizing position and orientation of the display screen within the devices, can also be used to alter a shape of the light seal to better conform to a user's face. This improved and consistent contact between the light seal and the user's face can also distribute forces more evenly such that injuries from bumping or falling with the head-mountable device can be reduced. The adjustment mechanisms shown in the figures can also take other forms including adjustable spacers, screws, or other variable length mechanism to expand or contract thickness or distance of the light seal between the housing or frame of the display portions in the user's face. As noted above, the adjustments described with reference to adjustment mechanisms and variable length mechanism can be made by the user, retailer, and/or the manufacturer to optimize each head-mountable device to the unique anatomical features of each user without the need for multiple or excess SKUs.

Any of the features, components, and/or parts, including the arrangements and configurations thereof shown in FIGS. 5A-5C can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIGS. 5A-5C.

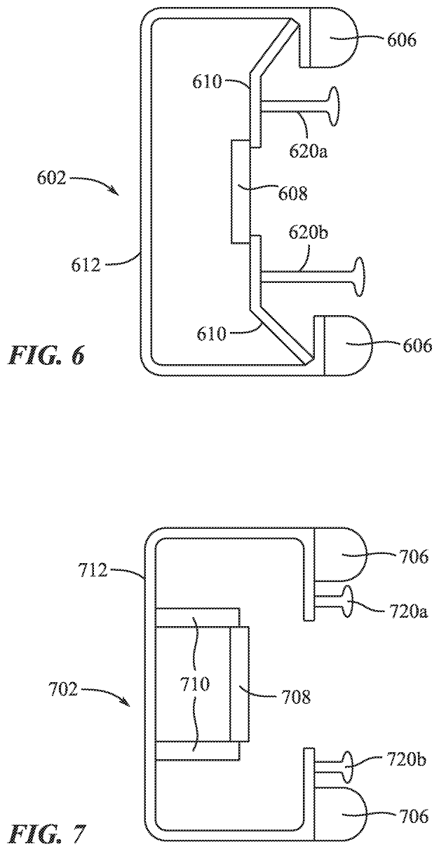

FIG. 6 illustrates a side cross-sectional view of another example of a display portion 602 of a head-mountable device. The display portion 602 can include a housing 612 and a display 608 coupled to the housing 612 via a frame 610. The display 608 can be connected to the frame 610. In addition, the display portion 602 can include a light seal 606 extending rearward from a rear surface of the display portion 602 and around a rear peripheral edge of the display portion 602. In at least one example, the housing 612 can define an external surface of the display portion 602 the housing 612 can be coupled to the frame 610 and the adjustment mechanism 620a and 620b can be coupled to the frame 610.

In such an example, the adjustment mechanism 620a and 620b can extend directly from the frame 610 and contact the user's face for adjusting a distance between the display 608 and the user's eye. As the adjustment mechanisms 620a and 620b connected to the frame 610 are altered, the light seal 606 can be formed of a compliant, soft, or elastic material that correspondingly compresses or expands to extend from the housing 612 to the user's face. In this way, the light seal 606 can maintain consistent and unbroken contact with a user's face to block out light as the adjustment mechanism 620a and 620b are altered to accommodate the user.

Any of the features, components, and/or parts, including the arrangements and configurations thereof shown in FIG. 6 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 6.

FIG. 7 illustrates a side cross-sectional view of another example of the display portion 702 of head-mountable device. The display portion 702 can include a housing 712 and a display coupled to the housing 712 via the frame 710. The display 708 can be connected to the frame 710. In addition, the display portion 702 can include a light seal 706 extending rearward from a rear surface of the display portion 702 and around a rear peripheral edge of the display portion 702. In at least one example, the housing 712 can define an external surface of the display portion 702. The housing 712 can be coupled to the frame 710 and the adjustment mechanism 720a and 720b can be coupled to the housing 712 but not within an internal volume of the light seal 706. Such an example, the adjustment mechanisms 728 and 720 be can be disposed elsewhere on the housing 712. Light seal 706 can be formed of soft or elastic material expanding and contracting between the housing 712 and the user's face when the display portion 702 is donned such that the adjustment mechanism 720a and 720b can be altered and the light seal 706 can maintain contact extending between the housing 712 and the user's face and block out light.

Any of the features, components, and/or parts, including the arrangements and configurations thereof shown in FIG. 7 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 7.

FIGS. 6 and 7 illustrate examples of adjustment mechanisms 620a and 620b and 720a and 720b that can be located at various locations of the display portion 602, 702 and cause an adjustment in the light seal 606, 706 as the adjustment mechanisms are altered. The adjustment mechanisms described so far have included variable length mechanisms that can be changed to alter a length of the adjustment mechanisms and therefore changing thickness or other dimension of the light seals. However, other forms of adjustment mechanisms and means of altering the thickness, distances, or other dimensions of the light seals described herein are also contemplated.

For example, the adjustment mechanisms described herein can include and adjustable screw can be threaded one way or the other to increase or decrease its length. Another example can include an internal volume of a light seal that can be inflated or deflated to alter different areas or portions of the light seal. In one example, the light seal can be formed of material that when heated can be molded to a user's face and then cooled to set with contours complimenting the user's facial contours. In one example, the adjustment mechanism can include a track with spring release. Other mechanisms that alter the shape or dimensions of the light seals described herein are also contemplated.

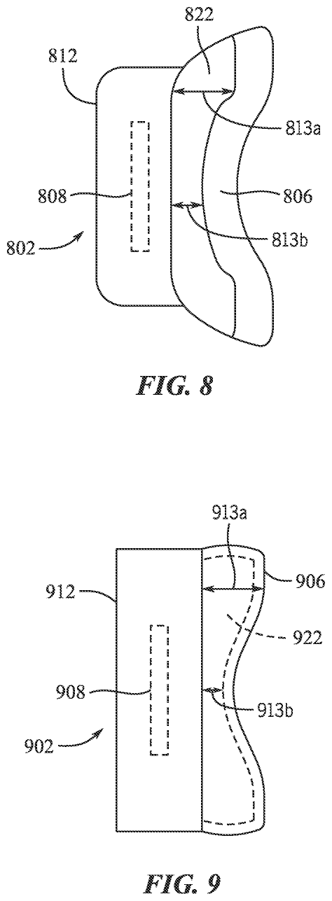

As shown in FIG. 8, in addition to or alternatively to the adjustment mechanisms described herein, one or more examples of light seals of display portion of head-mountable devices can include one or more spacers or shims 822 augmenting the contours, shape, thicknesses, or other features and dimensions of a light seal 806. FIG. 8 illustrates a side view of another example of a display portion 802 of head-mountable device. The display portion 802 can include housing 812 and a display 808. A light seal 806 conforming to the contours of the user's face in making consistent and unbroken contact therewith can extend from the housing as shown. In at least one example, a shim 822 can be sized, shaped, and otherwise formed to alter and control a surface topography of the light seal to match the surface topography of the user's face.

As noted above with reference to other adjustment mechanisms of light seals shown in other figures, shim 822 of FIG. 8 can be in addition to or alternative to such adjustment mechanisms. In any case, the shim 822 can alter various distances 813a and 813b of the light between the housing 812 to the user's face. In this way, the shim 822 can function like other adjustment mechanisms described herein to alter a distance and angle of the display 808 relative to the user's eyes for optimal performance.

The shim 822 can be custom formed based on an identified topography or topographical map of the user's face is detected or measured by the head-mountable device or one or more other electronic devices. The topography can also be matched manually using measurements taken by the user, the retailer, or the manufacturer. In such an example, the display portion 802, including the housing and the light seal 806, can be a common SKU for all users while the shim 822 can be customized or part of a limited number of SKUs with varying topographies to cover a wide range of anatomical variations of different users. In this way, manufacturing complexity and costs can be reduced by only requiring customization of the shim 822 or a selection of a limited number of shim SKUs.

FIG. 9 illustrates a side view of another example of the display component 902 including a housing 912, a display 908 disposed within the housing, and a light seal 906. A shim 922, which can be a customized shim similar to the shim 822 shown in FIG. 8, can be disposed within an internal volume of the light seal 906 such that the shim 922 his hidden from view and controls the contours and topography of a contact surface of the light seal 906 from inside the light seal 906.

Again, as noted above with reference to other adjustment mechanisms of light seals shown in other figures, shim 922 of FIG. 9 can be in addition to, or alternative to, such adjustment mechanisms. In any case, the shim 922 can alter various distances 913a and 913b of the light seal 906 between the housing 912 to the user's face. In this way, the shim 922 can function like other adjustment mechanisms described herein to alter a distance and angle of the display 908 relative to the user's eyes for optimal performance.

Any of the features, components, and/or parts, including the arrangements and configurations thereof shown in FIGS. 8 and 9 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIGS. 8 and 9.

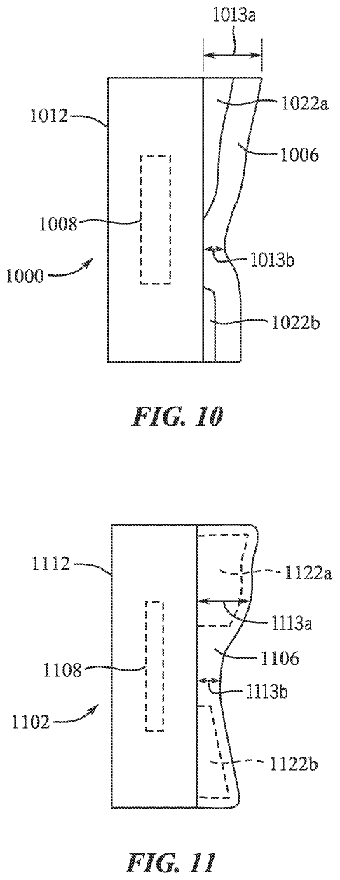

As shown in FIG. 10, in addition to or alternatively to the adjustment mechanisms described herein, one or more examples of light seals of display portions of head-mountable devices can include two or more spacers or shims 1022a, 1022b augmenting the contours, shape, thicknesses, or other features and dimensions of a light seal 1006. FIG. 10 illustrates a side view of another example of a display portion 1002 of head-mountable device. The display portion 1002 can include housing 1012 and a display 1008. A light seal 1006 conforming to the contours of the user's face in making consistent and unbroken contact therewith can extend from the housing as shown. In at least one example, a shim 1022 can be sized, shaped, and otherwise formed to alter and control a surface topography of the light seal to match the surface topography of the user's face.

As noted above with reference to other adjustment mechanisms of light seals shown in other figures, shims 1022a and 1022b of FIG. 10 can be in addition to or alternative to such adjustment mechanisms. In any case, the shims 1022a and 1022b can alter various distances 1013a and 1013b between the housing 1012 to the user's face. In this way, the shims 1022a and 1022b can function like other adjustment mechanisms described herein to alter a distance and angle of the display 1008 relative to the user's eyes for optimal performance.

The shims 1022a and 1022b can be custom formed based on an identified topography or topographical map of the user's face is detected or measured by the head-mountable device or one or more other electronic devices. The topography can also be matched manually using measurements taken by the user, the retailer, or the manufacturer. In such an example, the display portion 1002, including the housing and the light seal 1006, can be a common SKU for all users while the shims 1022a and 1022b can be customized or part of a limited number of SKUs with varying topographies to cover a wide range of anatomical variations of different users. In this way, manufacturing complexity and costs can be reduced by only requiring customization of the shims 1022a and 1022b or a selection of a limited number of shim SKUs.

FIG. 11 illustrates a side view of another example of the display component 1102 including a housing 1112, a display 1108 disposed within the housing, and a light seal 1106. Two separate shims 1122a, 1122b, which can be customized similar to shim 1022a and 1022b shown in FIG. 10, can be disposed within an internal volume of the light seal 1106 such that the shims 1122a and 1122b are hidden from view and controls the contours and topography of a contact surface of the light seal 1106 from inside the light seal 1106.

Again, as noted above with reference to other adjustment mechanisms of light seals shown in other figures, shim 1122 of FIG. 11 can be in addition to, or alternative to, such adjustment mechanisms. In any case, the shims 1122a and 1122b can alter various distances 1113a and 1113b between the housing 1112 to the user's face. In this way, the shims 1122a and 1122b can function like other adjustment mechanisms described herein to alter a distance and angle of the display 1108 relative to the user's eyes for optimal performance.

Any of the features, components, and/or parts, including the arrangements and configurations thereof shown in FIGS. 10 and 11 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIGS. 10 and 11.

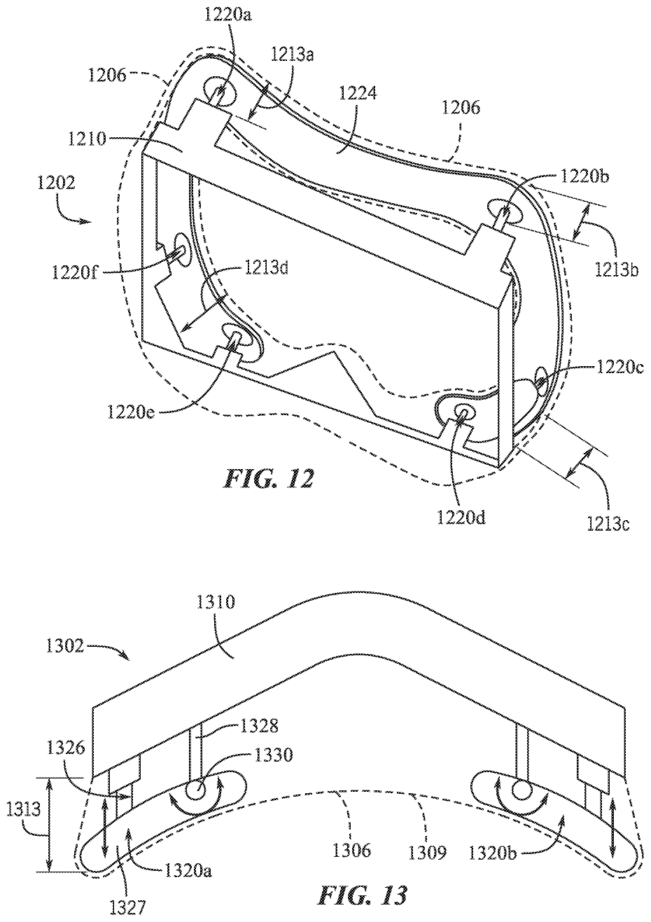

FIG. 12 illustrates an example of a portion of a display portion 1202 including a frame 1210 and a track 1224 extending rearward from the frame 1210 and connected to the frame 1210 via a number of adjustment mechanisms 1220 a-f. The track 1224 and the frame 1210 can be encompassed by sheath or other component of the light seal 1206 such that the frame 1210 and/or the track 1224 and/or the adjustment mechanisms 1220a-f are hidden from view. In at least one example, the track 1224 can form a contact surface configured to press against the user's face when the head-mountable device is donned. In one example, the display portion 1202 can include a number of separate and distinct adjustment mechanisms 1220a, 1220b, 1220c, 1220d, 1220e, and 1220f. The adjustment mechanisms 1220a-f can be referred to collectively as adjustment mechanisms 1220.

Each adjustment mechanism 1220 can be similar to others such that the description of one can apply to all the adjustment mechanisms 1220. Each adjustment mechanism 1220 can extend from the frame 1210 to the track 1224 and include a variable length mechanism. In this way, first, second, third, fourth, fifth, sixth, and any other number of adjustment mechanisms 1220 can be individually altered to adjust a distance 1213 from the frame to the user's face. In this way, the distance 1213 can be altered to various degrees at different points along the track 1224 relative to the frame of 10 corresponding to positions of each adjustment mechanism 1220. The length of each adjustment mechanism 1220 can be individually changed by the user, the retailer, or the manufacturer, to alter the shape and topography of the track 1224 within the light seal 1206 to match the shape and topography of an individual users anatomical features. In this way, a single SKU of the display portion 1202 shown in FIG. 12 can be manufactured to simplify cost and manufacturing complexity while providing each user unique configurations to optimize display positions and orientations as described herein.

The locations of each adjustment mechanism 1220 can correspond to certain portions of the light seal 1206, with each portion of the light seal 1206 corresponding to a distance 1213 between the frame 1210 or a housing of the display portion 1202 and the user's face. For example, the first adjustment mechanism 1220a can correspond to a first upper portion of the light seal 1206 defining a first distance 1213a between the frame 1210 and the user's face and the second adjustment mechanism 1220b can correspond to a second upper portion of the light seal 1206 defining a second distance 1213b between the frame 1210 and the user's face. In addition, a third adjustment mechanism 1220c or 1220d can correspond to a first lower portion of the light seal 1206 and define a third distance 1213c between the frame 1210 an the user's face and a fourth adjustment mechanism 1220e or 1220f can correspond to a second lower portion of the light seal 1206 and define a fourth distance 1213d between the frame 1210 and the user's face. Each distance 1213 can be altered to accommodate the user.

The adjustment mechanisms of light seals and head-mountable devices described herein can include multiple mechanisms, including multiple variable length mechanisms, pivot mechanisms, screws, shims, spacers, and so forth, which can collectively be referred to as a single adjustment mechanisms. For example, in FIG. 12, the adjustment mechanisms 1220a-f can be considered each a part of a single adjustment mechanism configured to alter the shape, curvature, or various distances from the housing of the light seal 1206 and the track 1224 pressing against a user's face during use. Another example includes FIGS. 5A-5C, which show first and second adjustment mechanisms 520a and 520b. These adjustment mechanisms 520a and 520b can be referred to as a single adjustment mechanism altering the dimensions and shape of a single light seal 506 extending from the housing 512.

Any of the features, components, and/or parts, including the arrangements and configurations thereof shown in FIG. 12 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 12.

FIG. 13 illustrates another example of the display portion 1302 of the head-mountable device. FIG. 13 illustrates a top view of the display portion 1302 including a frame 1310 and a light seal 1306 extending rearward from the frame 1310. As noted above with respect to other examples, the frame 1310 can be a part of a housing, extend from a housing, or the light seal 1306 can extend directly from the housing coupled to the frame 1310. In the illustrated example of FIG. 13, adjustment mechanisms 1320a and 1320b extend from the frame within the light seal 1306, for example within an internal volume defined by the light seal 1306.

In at least one example, the first and second adjustment mechanisms 1320a and 1320b, respectively, can be similar such that the description of one applies to both. The first adjustment mechanism 1320 a can include a foot 1327 coupled to the frame 1310 via a variable length mechanism 1326 and a member 1328 fixed to the frame 1310 at one end and rotatably fixed to the foot 1327 at a second end via a pivot mechanism 1330. In at least one example, the variable length mechanism 1326 can be adjusted to increase or decrease length thereof such that the foot 1327 can rotate about 1330 to alter an angle of the foot 1327 relative to the frame 1310. The alteration of this angle can adjust the topography of a contact surface 1309 of the light seal 1306 to better conform to a user's face and adjust a position of one or more components, including a display screen, of the display portion 1302 relative to the user's eyes.

The rotation of the foot 1327 about the pivot mechanism 1330 can also adjust the distance 1313 between the frame content or housing of the display portion 1302 and the contact surface 1309 of the light seal 1306. Additionally, in at least one example, member 1328 can also be length adjustable to further provide a degree of freedom to the foot 1327 to be adjusted as needed.

Any of the features, components, and/or parts, including the arrangements and configurations thereof shown in FIG. 13 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 13.

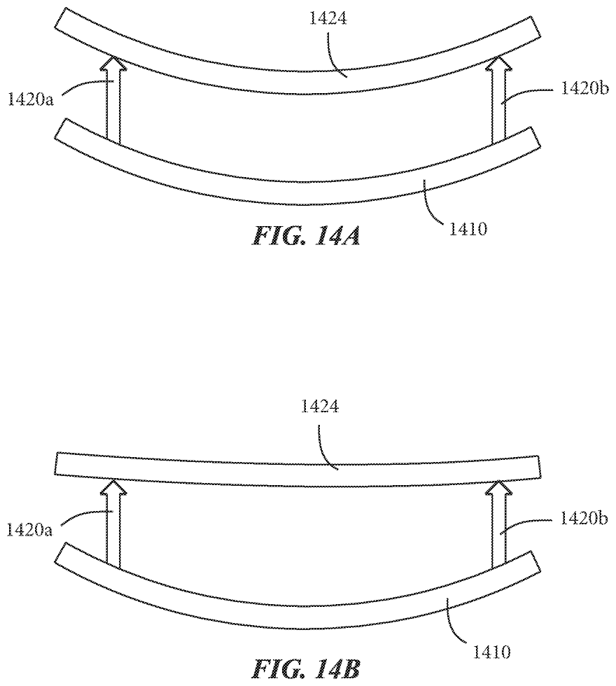

FIG. 14A illustrates an example of a head-mountable device, including a frame 1410 and a track 1424 adjustably secured together via one or more adjustment mechanisms 1420a-b, which are represented as arrows to indicate the adjustable length thereof. FIG. 14A shows an example of a device with the track 1424 shaped and formed to accommodate a first user forehead, and FIG. 14B shows the track 1424 adjusted to accommodate a second user forehead, which is flatter than the first shown in FIG. 14A. In both examples, the frame 1410 remains consistent in shape and position.

As illustrated, the adjustment mechanisms 1420a-b can be adjusted to change the shape of the face track 1424, for example, from a flatter configuration shown in FIG. 14B to a more curved configuration shown in FIG. 14A, to accommodate different shaped heads. As indicated by the arrows representing the adjustment mechanisms 1420a-b, the adjustment mechanisms 1420a-b can each be length-adjustable to vary a distance between the track 1424 and the frame 1410 at any given point where the adjustment mechanisms 1420a-b are positioned in order to alter the shape of the track 1424.

Any of the features, components, and/or parts, including the arrangements and configurations thereof shown in FIGS. 14A and 14B can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIGS. 14A and 14B.

In some examples, personal data can be collected by the present exemplary system and method, in order to improve the user experience or performance of the product. If personal data is utilized, it should be collected, stored, and used in accordance with commonly accepted standards and procedures. However, the present exemplary systems and methods are fully functional and can operate without the collection and use of personal data.

The present description is provided for purposes of explanation only, and is not intended to limit or to be considered exhaustive of the various combinations that can be used to practice the present invention. Rather, many modifications and combinations are possible in light of the above teachings.

What is claimed is:

1. A head-mountable device, comprising:
a display portion including a housing and a display;
a light seal extending from the housing and including a contact surface offset from the housing by a distance; and
an adjustment mechanism configured to alter the distance.

2. The head-mountable device of claim 1, the light seal comprising a compliant sheath defining an internal volume.

3. The head-mountable device of claim 2, the adjustment mechanism comprising a foot disposed at least partially within the internal volume.

4. The head-mountable device of claim 3, further comprising a frame coupled to the housing, wherein the foot connects to the frame and an angle of the foot relative to the frame is adjustable.

5. The head-mountable device of claim 1, further comprising a frame, wherein:
the housing defines an external surface of the display portion;
the housing is coupled to the frame; and
the adjustment mechanism is coupled to the frame.

6. The head-mountable device of claim 5, wherein the adjustment mechanism is coupled to the frame and extends into the light seal.

7. The head-mountable device of claim 6, wherein the light seal hides the adjustment mechanism from view.

8. An electronic display device, comprising:
a housing defining a front side and a rear side opposite the front side;
a light seal extending from the rear side, the light seal having an upper portion extending a first distance from the housing and a lower portion extending a second distance from the housing; and
an adjustment mechanism disposed in the light seal and defining the first distance or the second distance.

9. The electronic display device of claim 8, wherein the upper portion is a first upper portion and the lower portion is a first lower portion, the light seal further comprising a second upper portion extending a third distance from the housing and a second lower portion extending a fourth distance from the housing.

10. The electronic display device of claim 9, wherein the adjustment mechanism is configured to independently alter the first distance, the second distance, the third distance, and the fourth distance.

11. The electronic display device of claim 8, further comprising a frame, the housing coupled to the frame;
wherein the adjustment mechanism comprises a first foot coupled to the frame and a second foot coupled to the frame.

12. The electronic display device of claim 11, wherein the first foot is coupled to the frame via a variable length mechanism.

13. The electronic display device of claim 11, wherein the first foot is coupled to the frame via a pivot mechanism.

14. The electronic display device of claim 11, wherein at least one of the first foot or the second foot is coupled to the housing via the frame.

15. The electronic display device of claim 8, further comprising a display, wherein adjusting the first distance or the second distance alters an angle or distance of the display relative to a user's eye.

16. A head-mountable electronic device, comprising:
a display portion including a display screen;
a light seal connected to the display portion, the light seal including an adjustment spacer and a contact surface; and
a securement strap configured to hold the display screen at a distance and an angle relative to the contact surface,
the adjustment spacer is configured to alter the distance and the angle.

17. The head-mountable electronic device of claim 16, wherein the contact surface is configured to press against a face and block ambient light from impinging on the display screen.

18. The head-mountable electronic device of claim 16, the adjustment spacer including a first variable length mechanism coupled to the display portion and a second variable length mechanism coupled to the display portion.

19. The head-mountable electronic device of claim 18, wherein changing a length of the first variable length mechanism alters the distance or the angle.

20. The head-mountable electronic device of claim 16, wherein the light seal defines an internal volume and the adjustment spacer is disposed within the internal volume.
